(19) United States
(12) Patent Application Publication
(10) Pub. No.: US 2013/0329848 A1
(43) Pub. Date: Dec. 12, 2013

(54) CAMERA INSPECTION ARM FOR BOILING WATER REACTOR

(71) Applicant: Vista Engineering Technologies, Richland, WA (US)

(72) Inventor: Paul Damon Linnebur, Milliken, CO (US)

(21) Appl. No.: 13/916,063

(22) Filed: Jun. 12, 2013

Related U.S. Application Data
(60) Provisional application No. 61/658,901, filed on Jun. 12, 2012.

(51) Int. Cl. G21C 17/013

(52) U.S. Cl. CPC G21C 17/013
USPC 376/249

(57) ABSTRACT

There is disclosed a remotely deployed and operated boiling water reactor camera inspection arm. In an embodiment, the remotely deployed and operated boiling water reactor camera inspection arm has a vertical actuator, that includes a bi-stable lightweight reelable tube configurable from a rolled retracted state to an extended tubular state by unrolling downwardly, and back to a rolled retracted state by rolling upwardly. An inspection camera is attached to an end of the reelable tube. Other embodiments are also disclosed.

### REFERENCE TO PENDING PRIOR PATENT APPLICATION

This application claims the benefit under 35 U.S.C. 119 (e) of U.S. Provisional Patent Application No. 61/658,901, filed Jun. 12, 2012 by Paul Damon Linnebur for “CAMERA INSPECTION ARM FOR BOILING WATER REACTOR” which patent application is hereby incorporated herein by reference.

### BACKGROUND

Generally, a boiling water reactor is a type of light water nuclear reactor used for the generation of electrical energy. In a boiling water reactor, a reactor core heats water, which turns to steam, and then drives a steam turbine. Camera inspection is a highly desirable form of preventive maintenance within a boiling water reactor. Water currents in the reactor push the camera around, but a stable image is needed. Traditionally, an operator with a camera mounted on a long pole, typically fifty feet in length, would selectively position the camera in the reactor. This requires significant experience and subjects the operator to a significant amount of radiation even with the water as a shield.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided for a remotely deployed and operated boiling water reactor camera inspection arm that includes a vertical actuator, comprising a rolatube having a rotated hub to extend and retract the rolatube vertically. A radiation tolerant, submersible, pan-tilt-zoom inspection camera is attached to an end of the rolatube for moving the camera vertically downward by extending the rolatube and for moving the camera vertically upward by retracting the rolatube.

In another embodiment, there is provided for a remotely deployed and operated boiling water reactor camera inspection arm that includes a central mast. In accordance with some embodiments, this central mast might include a central vertical stanchion, a hoist ring disposed at a top of the stanchion, a wedge bumper extending from a side of the stanchion, an extensible wedge cylinder extending in horizontally opposition relative to the wedge bumper from another side of the mast, a locating plate and a deployment actuator plate, each disposed at a bottom of the mast extending generally horizontal, perpendicular to the mast. The locating plate may define a beam bolt interface. The mast might further include a mount plate disposed at the top of the stanchion.

At least one deployment actuator is mounted on the mast, such as by way of example, on the deployment actuator plate. In accordance with various embodiments each of the deployment actuators has a base frame and an articulation mechanism operatively mounted to a top of the base frame. Also, this articulation mechanism may be a four-bar mechanism mounted to the top of the base frame and/or includes a disengagement mechanism, in accordance with certain embodiments.

At least one vertical actuator is deployed on each deployment actuator. In accordance with various embodiments, each vertical actuator includes a bi-stable lightweight reelable tube reconfigured from a rolled retracted state to an extended tubular state by unrolling, and back to a rolled retracted state by rolling. This reelable tube may be a rolatube, which may have a rotated hub to extend and retract the rolatube. In accordance with some embodiments, the vertical actuators each include a guide for the rolatube that forms the rolatube into a tube upon extension and flattens the rolatube upon retraction.

At least one radiation tolerant, submersible, pan-tilt-zoom inspection camera is deployed on the one vertical actuator, such as by way of example on an end of the rolatube. In such embodiments, the camera (or its mount) may maintain a working end of the rolatube rolled in a cylindrical shape. As noted above, rolatube may have a rotated hub to extend and retract the rolatube. This may be used to move the attached camera vertically. The vertical actuator may be operatively coupled to the articulation mechanism, to deploy a camera horizontally, in and out. A slew mechanism mounted on a bottom of the mast may operatively engage and rotate the deployment actuator with respect to the mast to deploy the at least one camera horizontally, side-to side. The slew mechanism may also include a disengagement mechanism.

In another embodiment, there is provided a method for inspecting a boiling water reactor, which might include lowering a boiling water reactor camera inspection arm into a reactor vessel, between the reactor vessel and a reactor shroud. In accordance with some embodiments, the boiling water reactor camera inspection arm may be lowered using a hoist ring disposed in a top of a mast of the boiling water reactor camera inspection arm. Articulation mechanisms of the deployment actuators may be retracted before lowering the boiling water reactor camera inspection arm (or raising it).

A locating plate of the boiling water reactor camera inspection arm may be aligned on a reactor structure to install the boiling water reactor camera inspection arm for inspection of at least a portion of the reactor. In accordance with some embodiments, such alignment might include positioning the locating plate of the boiling water reactor camera inspection arm over bolts, such as beam bolts, on a top of a ram's head of a reactor jet pump. In such embodiments, the bolts may act as horizontal capture pins, indexing with the locating plate.

A wedge cylinder may be extended from a mast of the boiling water reactor camera inspection arm to engage the shroud and the vessel with the wedge cylinder and an opposing wedge bumper, stabilizing the boiling water reactor camera inspection arm against the shroud and the vessel.

One or more cameras of the boiling water reactor camera inspection arm may be positioned around reactor pipework, horizontally, by rotating, extending and/or retracting a deployment actuator of the boiling water reactor camera inspection arm. Then the cameras may be moved vertically on an end of a rolatube deployed from a vertical actuator deployed from the deployment actuator to inspect the reactor. In accordance with various embodiments, a top of the structure may be inspected using the one or more cameras during the lowering of the boiling water reactor camera inspection arm or while raising the boiling water reactor camera inspection arm out of the reactor vessel.

The boiling water reactor camera inspection arm may be recovered in the event of failure by disengaging a slew drive and articulation drive of the deployment actuator and removing the boiling water reactor camera inspection arm from the reactor vessel, in accordance with some embodiments.

In a particular embodiment, a remotely deployed and operated boiling water reactor camera inspection arm includes a mast having a central vertical stanchion and a plate extending generally horizontal, perpendicular to the stanchion, at the bottom of the mast. A pair of pneumatically actuated deployment actuators are mounted on the plate, one on each side of the mast stanchion. Each deployment actuator has a pneumatically actuated articulation mechanism operatively mounted to a top of a base frame of each of the deployment actuators. A vertical actuator is deployed on an end of each of the articulation mechanisms. Each vertical actuator has a rolatube, with the rolatube having a pneumatically rotated hub extending and retracting the rolatube. A radiation tolerant, submersible, pan-tilt-zoom inspection camera is deployed on an end of the rolatube of each vertical actuator. The rolatube extends and retracts to deploy the camera vertically. A pair of pneumatically actuated slew mechanisms mounted on a bottom of the mast, each operatively engage and rotate a deployment actuator with respect to the mast to deploy the camera horizontally, side-to side. The slew mechanism also includes a disengagement mechanism. A pneumatically actuated articulation drive of each articulation mechanism is operative to extend and retract the articulation mechanism, deploying the cameras horizontally, in and out. The articulation drive also has a disengagement mechanism.

Other embodiments are also disclosed.

Other objects, features, and advantages of the invention will become apparent from the following detailed description of the invention with reference to the accompanying drawings.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates an exemplary embodiment of an assembled CIA, according to one embodiment;

FIG. 2 illustrates an disassembled, some what exploded view of the CIA of FIG. 1, according to one embodiment;

FIG. 3 illustrates a mast of the CIA of FIG. 1, according to one embodiment;

FIG. 4 illustrates another view of the mast of FIG. 3, according to one embodiment;

FIG. 5 illustrates a fragmented, generally cross-sectional, view of a slewing mechanism for a deployment actuator of the CIA of FIG. 1, according to one embodiment;

FIG. 6 illustrates a deployment actuator of the CIA of FIG. 1, according to one embodiment;

FIG. 7 illustrates another view of the deployment actuator of FIG. 6, according to one embodiment;

FIG. 8 illustrates a camera and vertical actuator a of the CIA of FIG. 1, according to one embodiment;

FIG. 9 illustrates an enlarged view of the vertical actuator of FIG. 8, according to one embodiment;

FIG. 10 illustrates a perspective view of the CIA of FIG. 1 being lowered into a vessel, according to one embodiment;

FIG. 11 illustrates a side view of the CIA of FIG. 1 being lowered into a vessel, according to one embodiment;

FIG. 12 illustrates the CIA of FIG. 1 installed and aligned on a ram's head, according to one embodiment;

FIG. 13 illustrates inspection of a restraint bracket using the CIA of FIG. 1, according to one embodiment;

FIG. 14 illustrates a control panel for the CIA of FIG. 1, according to one embodiment;

FIG. 15 illustrates an example visibility map of a top portion of a jet pump related to use of the CIA of FIG. 1, according to one embodiment;

FIG. 16 illustrates an example visibility map of a bottom portion of a jet pump related to use of the CIA of FIG. 1, according to one embodiment;

FIG. 17 illustrates an embodiment of a drive disengagement mechanism with a collar engaged with a spline; and

FIG. 18 illustrates the embodiment of FIG. 17 of a drive disengagement mechanism, with the collar disengaged with the spline.

### DETAILED DESCRIPTION

### Overview

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

In an embodiment, there is provided for a remotely deployed and operated Camera Inspection Arm (CIA) for a boiling water reactor. In particular, the present CIA is a remotely operated robotic camera inspection arm. In various embodiments, at least one radiation tolerant inspection camera is deployed on a one vertical actuator, such as by way of example, on a working end of a reelable tube, such as a rolatube. For best performance the camera should have one or more pan, tilt and/or zoom features. In accordance with some embodiments, the camera could be mounted in a package to achieve the radiation or submersible features. In operation, as discussed in greater detail below, the CIA is positioned over a ram's head of a reactor, which is the top portion of a jet pump connected to the reactor's shroud. This jet pump may be the subject of inspection by the present CIA. The jet pump is connected to a reactor shroud. The shroud is a structure surrounding a reactor core, inside of the jet pumps. The reactor vessel is located outside of the jet pumps. A restraint bracket may be located approximately 6 feet below the top of the ram's head and retains the jet pump assembly in place. The tub is a walkway that floats above the shroud. The CIA is deployed from the tub.

### An Exemplary CIA

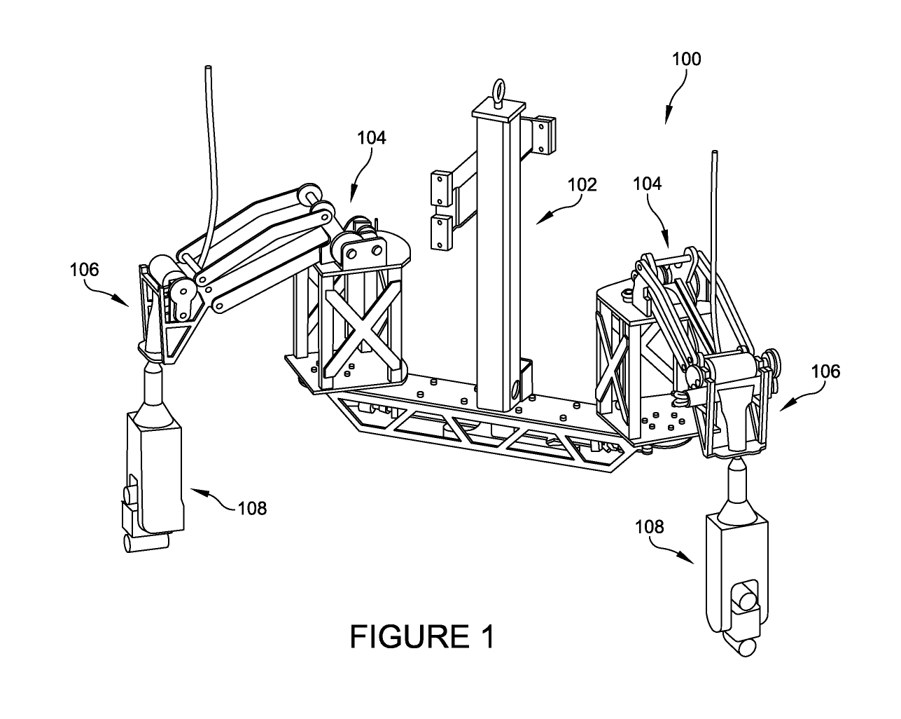

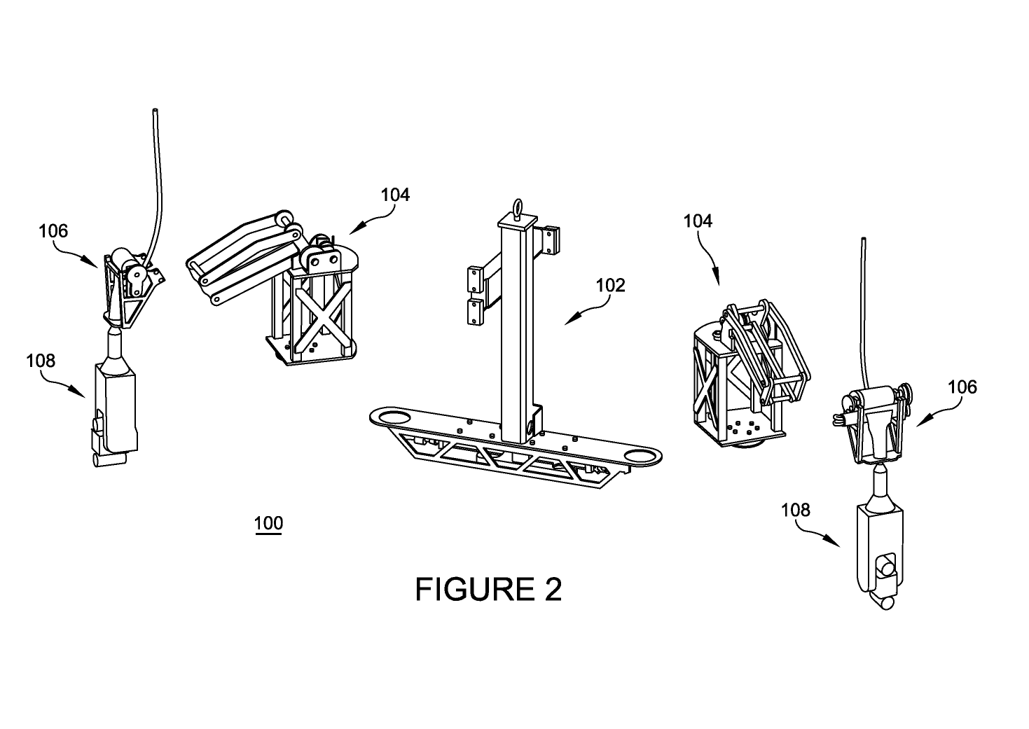

In one embodiment, there may be provided CIA 100, as shown in FIG. 1, having central vertical mast 102 one or more pneumatically actuated deployment actuators 104 mounted on vertical mast 102, vertical actuator 106 deployed on each deployment actuator 104, and at least one radiation tolerant, submersible, pan-tilt-zoom inspection camera 108 deployed from vertical actuator 106. More particularly, the embodiment of CIA 100 shown in FIG. 1 has twin (identical) pneumatically actuated deployment actuators 104, mounted on either side of a single vertical mast 102, that deploy radiation tolerant, submersible, PTZ inspection cameras 108, via (identical) vertical actuators 106. Other embodiments may include other numbers of actuators and cameras (e.g., one camera, three cameras, or additional cameras). As noted, the cameras could be mounted in a package, such as a case, to achieve the radiation or submersible features. FIG. 2 illustrates a disassembled, somewhat exploded, view of CIA 100 inspection arm of FIG. 1, according to one embodiment.

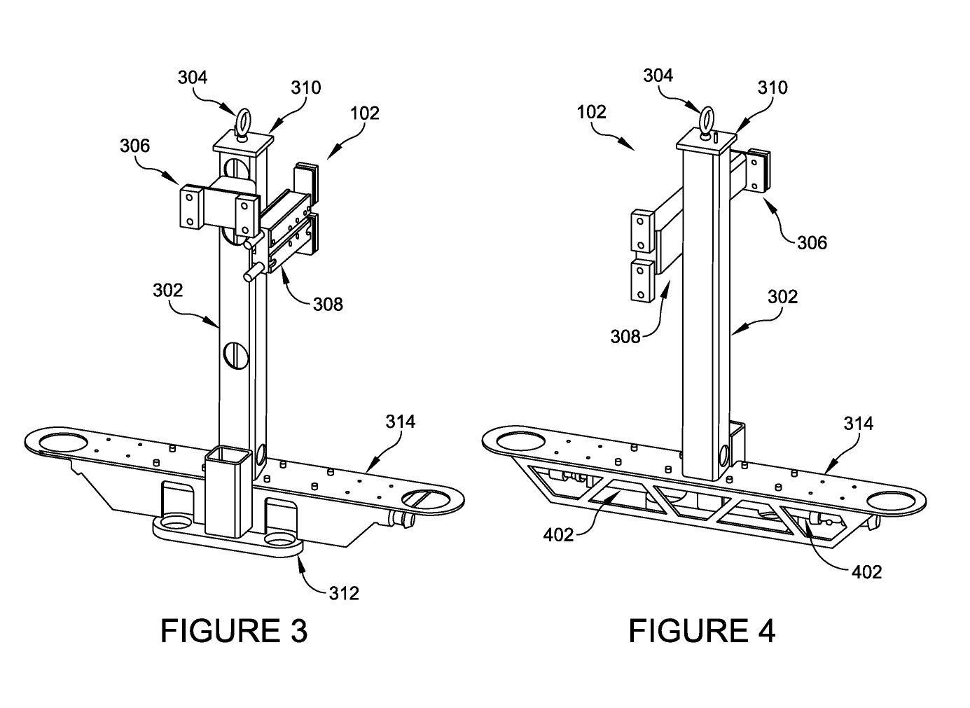

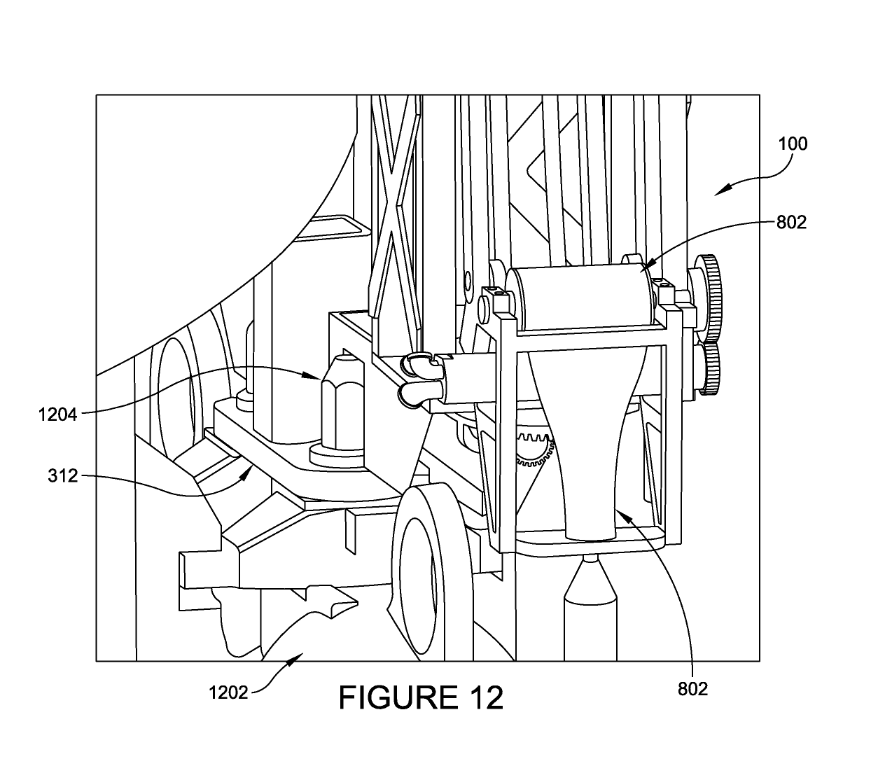

With reference to FIGS. 1-4, particularly FIGS. 3 and 4, which illustrate mast 102 of CIA 100 of FIG. 1, according to one embodiment. Mast 102, which acts as the principal structural frame of inspection arm device 100, includes stanchion 302, with hoist ring 304, shown at the top of mast stanchion 302. Hoist ring 304 may be used to connect CIA 100 to a facility's deployment hoist to allow CIA 100 to be lowered into an annular space between a reactor vessel and shroud, in accordance with various embodiments. Wedge bumper 306 and wedge cylinder 308, extend in horizontal opposition, from near the top of mast station 302 to provide stability to CIA 100 when in operation. For example, once CIA 100 is positioned over a ram's head of a reactor, pneumatic wedge cylinder 308 is actuated, extending wedge cylinder 308 until wedge cylinder 308 and wedge bumper 306 contact the reactor vessel and the reactor shroud, wedging CIA 100 between the reactor vessel and shroud. Mount plate 310 disposed at the top of mast stanchion 302, may optionally be sized and configured to rest on the top of the reactor shroud, such that mount plate 310, together with wedge cylinder 308 and wedge bumper 306, transfers a majority of the weight of the CIA 100 to the reactor vessel, so as to reduce the vertical load on the reactor jet pump. Locating plate 312, at the bottom of mast 102, interfaces with beam bolts on a top of a reactor's ram's head, as discussed in greater detail below, with respect to FIG. 12. Thusly, locating plate 312 captures the bottom of CIA 100 in a horizontal direction, when deployed. Generally horizontal, deployment actuator plate 314, at a bottom of mast 102, allows deployment actuators 104 to be mounted to mast 102. Slew mechanism 402 is mounted on the bottom of deployment actuator plate 314 for engaging and rotating the deployment actuators 104 with respect to an axis of slew gear 508. In addition to these specific features, mast 102 may also act as a connection point for a CIA umbilical cord, which may include control cables for the actuators, control cable(s) for disengagement mechanisms (discussed below), camera output cables, and/or the like.

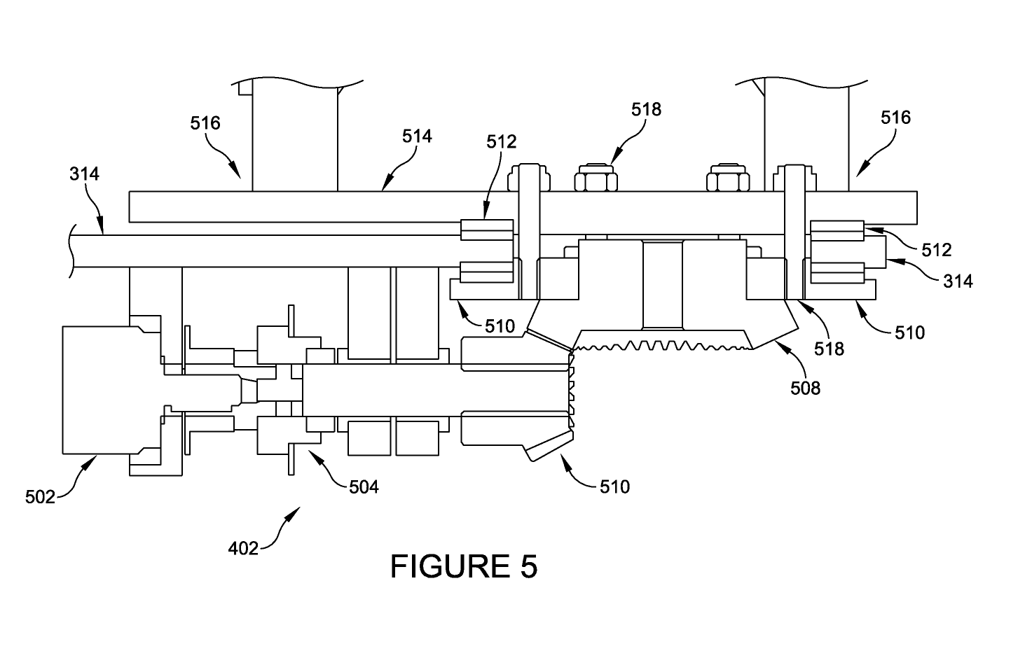

FIG. 5 illustrates a fragmented, generally cross-sectional, view of slewing mechanism 402 for deployment actuator 104 of CIA 100 of FIG. 1, according to one embodiment. As noted, slewing mechanism 402 is mounted to the bottom of deployment actuator plate 314. Slewing mechanism 402 includes pneumatic brake-motor 502, drive disengagement mechanism 504, motor gear 506, and slew gear 508, all operatively mounted on the bottom of deployment actuator plate 314. As noted, slew mechanism 402 rotates deployment actuators 104, and hence cameras 108, with respect to an axis of slew gear 508.

Deployment actuators 104 are illustrated in FIGS. 1, 2, 6 and 7, and partially in FIG. 5. Deployment actuators 104 may be configured to position cameras 108 horizontally. Deployment actuators 104 may be configured to each rotate with respect to an axis of slew gear 508. In one embodiment, deployment actuators 104 may include a four-bar linkage for in and out movement.

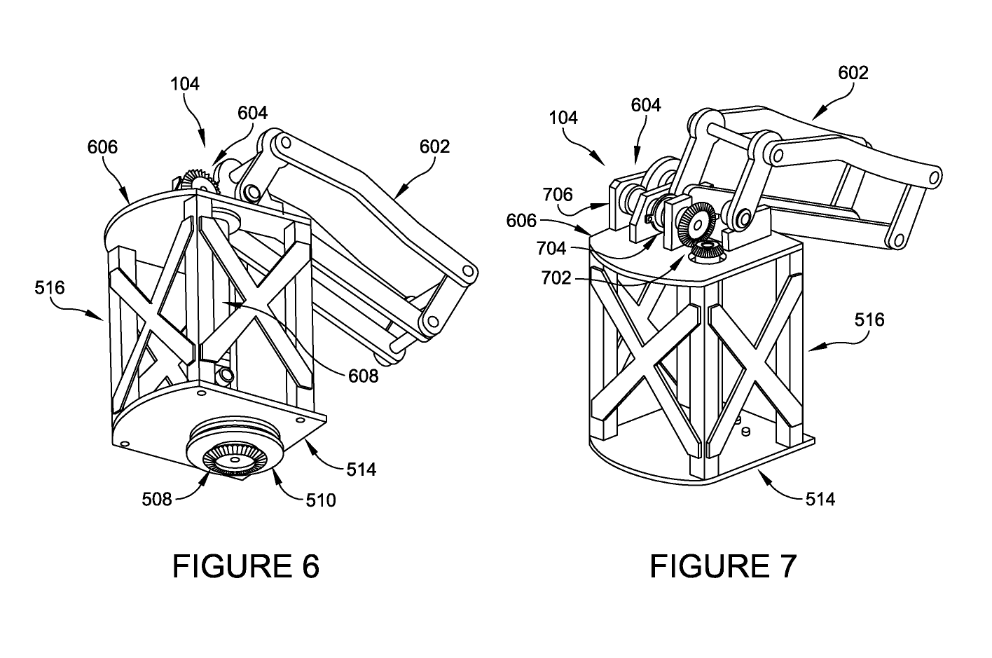

FIGS. 6 and 7 illustrate deployment actuator 104 of CIA 100 of FIG. 1, according to one embodiment. As noted, each deployment actuator 104 allows its camera 108 to articulate horizontally, that is, in and out with respect to the reactor jet pump being inspected. The entire deployment actuator assembly 104 rotates horizontally (slews) with respect to an axis of slew gear 508. These two articulations allow camera 108 to reach horizontal locations necessary to inspect the reactor jet pump being inspected.

With attention first directed back to FIG. 5, illustrated example deployment actuator 104 includes slewing gear 508, mounted using thrust bearing 510 and thrust washers 512 at bottom 514 of deployment actuator 104. Slewing gear 508, in conjunction with slewing mechanism 402, enables slewing of deployment actuator 104 with respect to an axis of slew gear 508. In accordance with various embodiments, slewing gear 508 is a bevel gear, and thrust bearing 510, with thrust washers 512, may sandwich mast deployment actuator plate 314 between it and bottom 514 of actuator base frame 516. Fasteners 518 that connect slewing gear 508 and thrust bearing 510 to bottom 514 of deployment actuator base frame 516 provide clamping force necessary to keep deployment actuator bearing 510 in compression against deployment actuator plate 314.

Returning to FIGS. 1, 2, 6 and 7 base frame 516 is the principal structural component of illustrated deployment actuator 104. Bottom 514 of base frame 516 is, as noted above, clamped to slewing gear 508 and bearing 510. Horizontal articulation mechanism 602 and its drive system 604 are mounted to top 606 of base frame 516. Illustrated articulation mechanism 602 is a four-bar mechanism mounted to top 606 of base frame 508. The use of a four-bar mechanism allows camera 108 to be articulated in and out at a constant orientation while being actuated with pneumatic motor 608 (as opposed to a pneumatic cylinder, or the like). In accordance with various embodiments, the use of pneumatic motor 608 provides finer position control than a pneumatic cylinder. Articulation drive motor 608 and associated release are mounted to top 606 of base frame 516 and operatively coupled with articulation mechanism 602. Hence, drive system 604 is comprised of a pneumatic brake motor 608, bevel gear set 702, drive disengagement mechanism 704, and spur gear set 706. This configuration allows drive 604 to be released for a failure event, and motor 608 to be mounted in a vertical orientation to minimize the envelope of CIA 100, in accordance with various embodiments. Additionally, the use of a four-bar articulation mechanism in the configuration shown ensures that if the drive mechanism is released, CIA 100 will collapse, allowing CIA 100 to be recovered from most any position.

Vertical actuators 106 are shown in FIGS. 1, 2 8 and 9. Camera vertical actuators 106 may be configured to position inspection camera 108 up and down. Vertical actuators 106 may be mounted on the end of deployment actuator 104. In the illustrated embodiment, camera vertical actuator 106 is attached to deployment actuator four-bar linkage articulation mechanism 602. Each camera vertical actuator 106 includes reelable tube 802, which may be bi-stable lightweight reelable tube reconfigured from a rolled retracted state to an extended tubular state by unrolling, and back to a rolled retracted state by rolling. This reelable tube may be a rolatube, which may be coupled to a pneumatically rotated hub 804. Each vertical actuator 106 extends and retracts its reelable tube 802 so as to move its inspection camera 108 up and down. Reelable tube 802 is a bi-stable lightweight reelable tube that enables deployment of inspection camera 108 rigidly, without requiring large articulated or prismatic robotic arms. Each of these reelable tubes is a bi-stable structure comprised of an extendable, coilable member that can be reconfigured from a rolled/coiled/retracted state to an extended tubular state by unrolling. The reelable tube is capable of reversible configuration from one state to the other and back an indefinite plurality of times. Thus, the reelable tube provides a small, compact form and provides a way to extend rigid tube down into a reactor, and retract it.

CIA 100 uses reelable tube 802 to support PTZ camera 108 while it is being deployed around a set of jet pumps within a boiling water reactor. Rolatube is well adapted for this use because it is made of materials that are designed to withstand the temperature and radiation in the reactor. Rolatube is a proprietary composite product made by Rolatube Technology, of Lymington, UK. The composite comprises multiple polymer types and other fibers. The polymers and fibers selected for this application will withstand both the temperature and radiation levels within the reactor. The fibers in reelable tube 802 are arranged in a manner such that reelable tube 802 becomes bi-stable (i.e. it will passively maintain its shape retracted as a coil or extended as a tube). As a tube, reelable tube 802 creates a stiff structure that dampens unwanted motions at camera 108 caused by water currents within the reactor and enable camera 108 to take high quality video of critical areas on the jet pumps in the reactor.

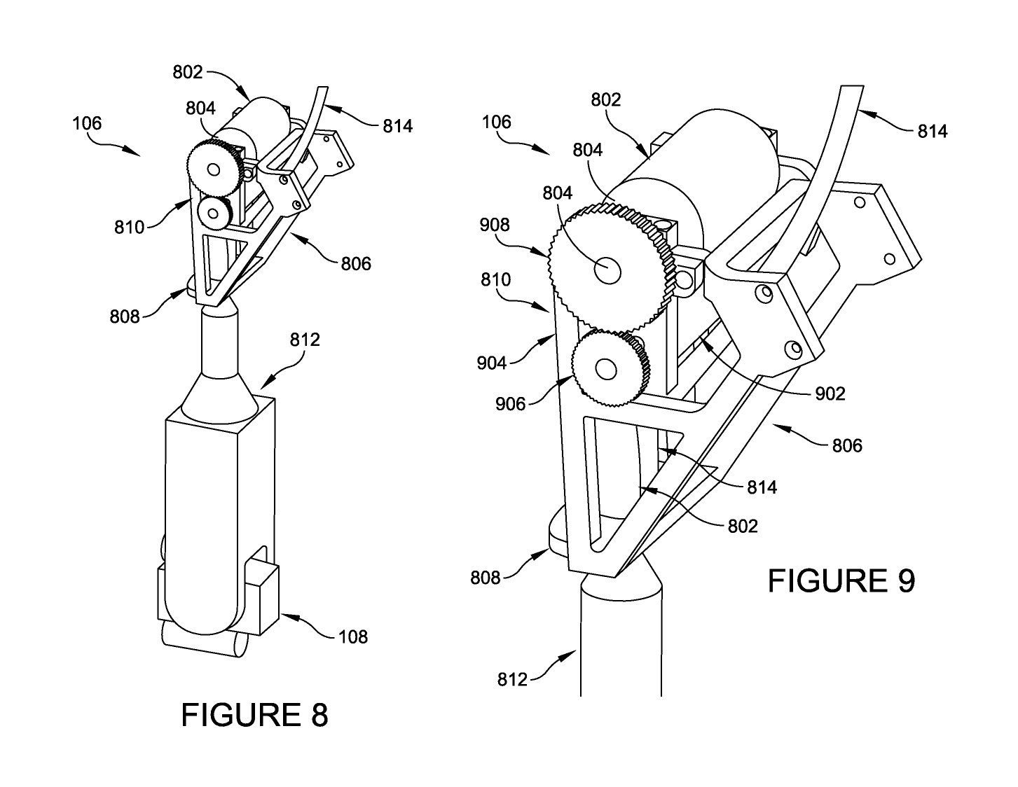

FIG. 8 illustrates camera 108 and vertical actuator 106 of CIA 100 of FIG. 1, according to one embodiment and FIG. 9 illustrates an enlarged view of vertical actuator 106 of FIG. 8, according to one embodiment. As noted, vertical actuator 106 moves inspection camera 108 up and down. Mount frame 806 is the principal structural component of camera vertical actuator 106. Mount frame 806 attaches to articulation mechanism 602, of deployment actuator 104. Bottom 808 of mount frame 806 defines a guide for reelable tube 802, which may act as a die, ensuring reelable tube 802 extends in a vertical orientation, forming a tube to provide horizontal rigidity, and ensuring reelable tube 802 rolls flat when retracted onto hub 804. Alternatively, this guide may, by way of example, take the form of two pinching rollers, wherein the reelable tube is driven between the rollers in its flattened state to drive the reelable tube up and down off the coil, whereupon it forms into a tubular column. Drive system 810 is composed of pneumatic brake-motor 902 and meshed spur gear set 904. Motor spur gear 906 is attached to the motor drive set 902 and reelable tube hub gear 908 is mounted on reelable tube hub 804. Reelable tube 802 and hub 804 allow camera 108 to be rigidly raised and lowered using a collapsible member. Reelable tube 802 is bi-stable, meaning it is stable in the rolled-up orientation (i.e. reelable tube 802 wound on hub 804) and in an extended orientation (i.e. forming a downwardly extending tubular column mounting camera 108). The use of a component such as rolatube 802 provides extended functionality to CIA 100, providing the ability for CIA 100 to collapse to a small envelope, while still having the ability to deploy camera 108 in a rigid manner. Thus, use of a component such as reelable tube 802 dramatically reduces the overall size, complexity, cost, and weight of CIA 100. Thus, use of a reelable tube type of component enhances the overall function of CIA 100. Without the ability to collapse to a small envelope, while still having the ability to deploy in a rigid manner, the overall size, complexity, cost, and weight of the CIA may increase dramatically.

Camera 108 is attached to an end of reelable tube 802, via camera mount 812. As noted above, the cameras can be deployed in a package, such as a case, to achieve the radiation or submersible features. Camera 108/camera mount 812 assists in keeping reelable tube 802 stable by holding the distal, free, working end of reelable tube 802 rolled in the aforementioned tubular, cylindrical shape, thereby not allowing the end of the reelable tube to deform (i.e., keeping the end of reelable tube 802 perpendicular to vertical actuator 106). This also keeps camera 108 rigidly attached to CIA 100, in accordance with various embodiments. The open tubular structure of reelable tube 802 also allows camera control and I/O cable 814 to be guided through the center of reelable tube 802 as it is extended, avoiding snagging of the cable.

### An Exemplary Procedure for Inspecting a Boiling Water Reactor

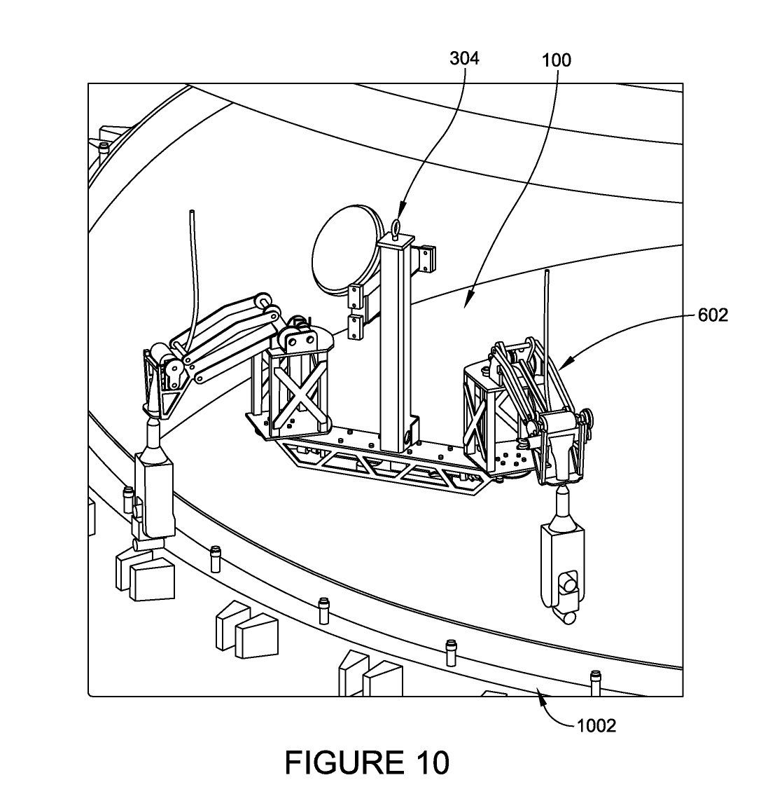

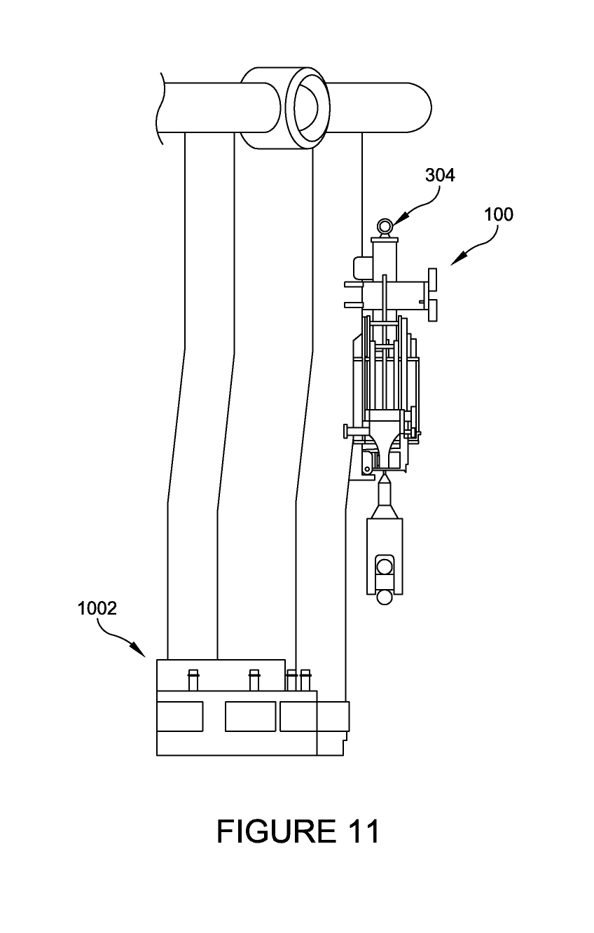

FIG. 10 illustrates a perspective view of CIA 100 of FIG. 1 being lowered into reactor vessel 1002, according to one embodiment, while FIG. 11 illustrates a side view of CIA 100 of FIG. 1 being lowered into reactor vessel 1002, according to one embodiment. CIA 100 may be connected to facilities hoist, such as via hoist ring 304 and lowered into a reactor vessel, to be positioned between the reactor vessel and the reactor's shroud. Articulation mechanisms 602 of deployment actuators 104 may be retracted to allow for easier installation of CIA 100 into this space.

FIG. 12 illustrates CIA 100 of FIG. 1 installed and aligned on ram's head 1202, according to one embodiment. Once CIA 100 is lowered into the annular space between the shroud and the vessel, CIA 100 can be positioned over beam bolts 1204 that are on a top of ram's head 1202. When CIA 100 is installed on the jet pump, beam bolts 1204 may act as horizontal capture pins, indexing with locating plate 312. Then, wedge pneumatic cylinder 308 may be extended, stabilizing CIA 100 against the shroud and the vessel.

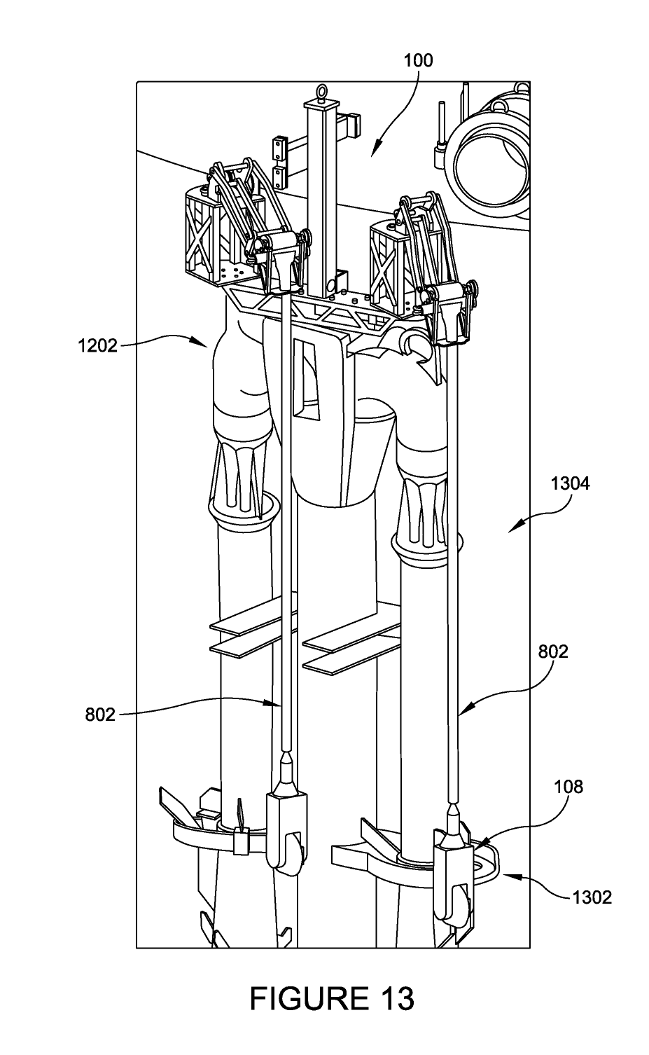

FIG. 13 illustrates inspection of restraint bracket 1302 using CIA 100 of FIG. 1, according to one embodiment. Restraint bracket 1302 may be located approximately 6 feet below the top of ram's head 1202. Once CIA 100 is installed over ram's head 1202 of jet pump 1304, each deployment actuator 104 can position its camera 108 around reactor jet pump pipework. Camera vertical actuators 106 can move cameras 108 up and down, using reelable tube 802, to inspect from ram's head 1202 to restraint bracket 1302, and beyond, if practical and desired. To inspect the very top welds of ram's head 1202, cameras 108 may be used either before CIA 100 is fully lowered on top of ram's head 120, or when CIA 100 is being raised after completion of all other inspections, such as of restraint bracket 1302.

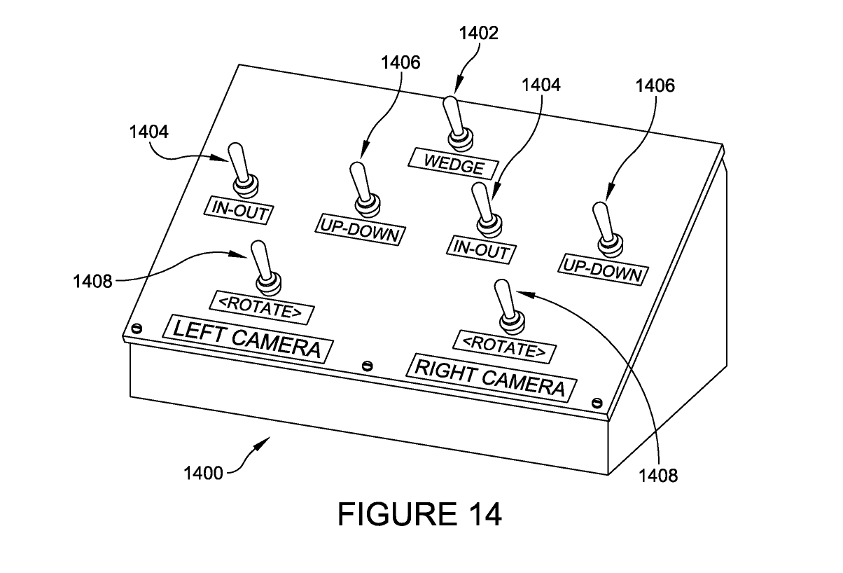

In various embodiments, CIA 100 is controlled with an all-pneumatic system, apart from the camera equipment. FIG. 14 illustrates control panel 1400 for CIA 100 of FIG. 1, according to one embodiment. An operator controls the joints of CIA 100 with pneumatic lever valves 1402-1408 from a single location. Pneumatic lines from illustrated control panel 1400 may be connected to CIA 100, via the aforementioned umbilical. Illustrated control panel embodiment 1400 includes wedge lever 1402 for extending wedge cylinder 308 until wedge cylinder 308 and wedge bumper 306 contact the reactor vessel and the reactor shroud, wedging CIA 100 between the reactor vessel and shroud, and for retracting wedge cylinder 308 to release CIA 100. In-out levers 1404 control respective right and left articulation mechanisms 602, particularly pneumatic articulation drive motor 608, to move the respective camera in and out (with respect to an axis of slew gear 508). Up-down levers 1406 control respective right and left vertical actuators 106, namely respective pneumatic brake-motors 902 to rotate respective reelable tube hub 804, lowering or raising respective reelable tube 802, and thereby respective camera 108. Rotation levers 1408 control slew of respective deployment actuators 104, via respective brake motors 502 of slewing mechanisms 402, rotating cameras 108, with respect to an axis of slew gear 508.

Because of the depths CIA 100 is required to operate under in the water surrounding the vessel, and because it is pneumatically operated, it may be desirable to adjust the operating pneumatic pressure of the systems of CIA 100 as it descends. This ensures that the system is operational as the hydrostatic pressure of the water increases. Thus, in various embodiments, CIA 100 may use backpressure compensation to pressurize the motors and system lines such that contaminated water is prevented from entering into the pneumatic motors and air lines. As described above, the actuations on CIA 100 are powered with pneumatic motors. Motors consist of rotating seals and other areas that have the potential for allowing contaminated water to enter the system. To prevent this, CIA 100 maintains a minimum air pressure within the motor and air lines. This back pressure may be manually set slightly higher than static pressure of the water in the reactor at the CIA's current depth as the CIA is lowered into the reactor.

In accordance with some embodiments maintaining the proper back pressure could be automated with the use of a bubble tube, a tube that is connected to the CIA but not connected to any actuator and is allowed flow a small amount of air. The pressure in the bubble tube could then be used as a reference to automatically set the backpressure on the system with the use of a differential pressure regulator.

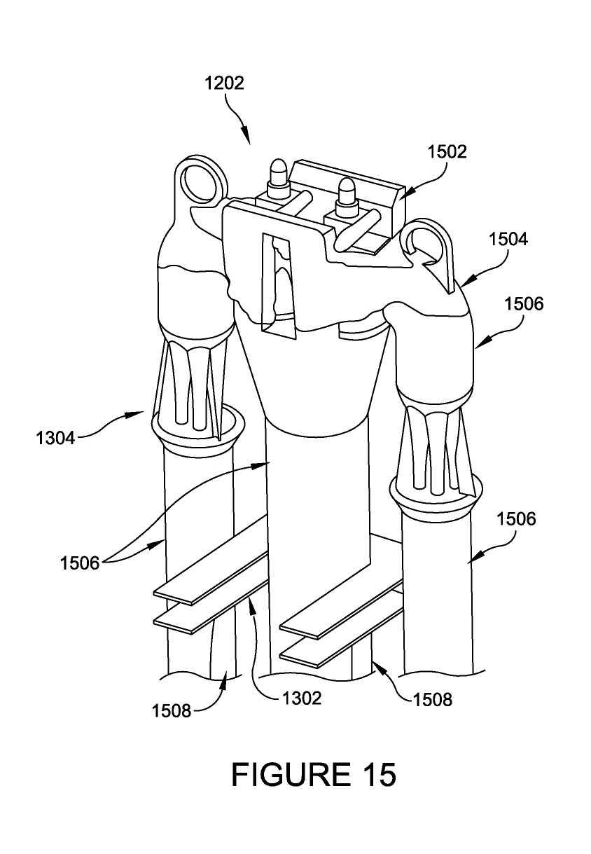

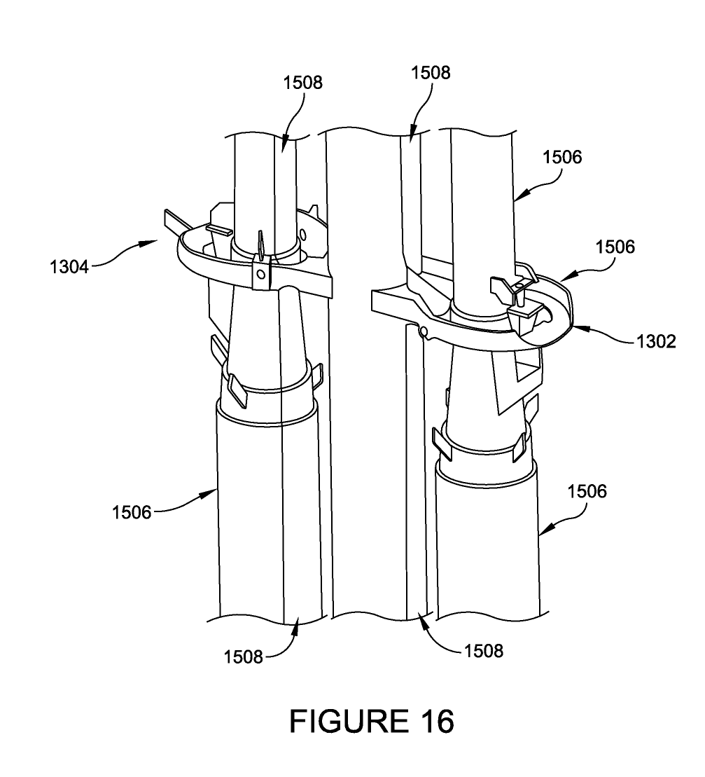

CIA 100 is able to inspect most portions of a jet pump when installed on the ram's head. As an example, FIGS. 15 and 16 show a visibility map of a jet pump, what portions of the jet pump may be expected to be visible by the camera. In particular, FIG. 15 illustrates an example visibility map of a top portion of jet pump 1304 related to use of CIA 100 of FIG. 1, according to one embodiment and FIG. 16 illustrates an example visibility map of a bottom portion of jet pump 1304 related to use of CIA 100 of FIG. 1, according to one embodiment. Therein, the area of jet pump 1304 indicated as 1502 is an area where cameras 108 can inspect only when CIA 100 is partially installed, as discussed above, i.e. the very top welds of ram's head 1202. The area indicated as 1504 can be partially inspected by camera 108, when CIA is installed, but can be fully inspected only when CIA 100 is partially installed. Areas designated 1506 are fully visible and inspectable using cameras 108 when CIA 100 is installed and operating, while 1508 areas are only partially visible to cameras 108. For example, in 1508 areas, such as by way of example, a weld in areas below restraint bracket 1302 may be visible from above, but not below.

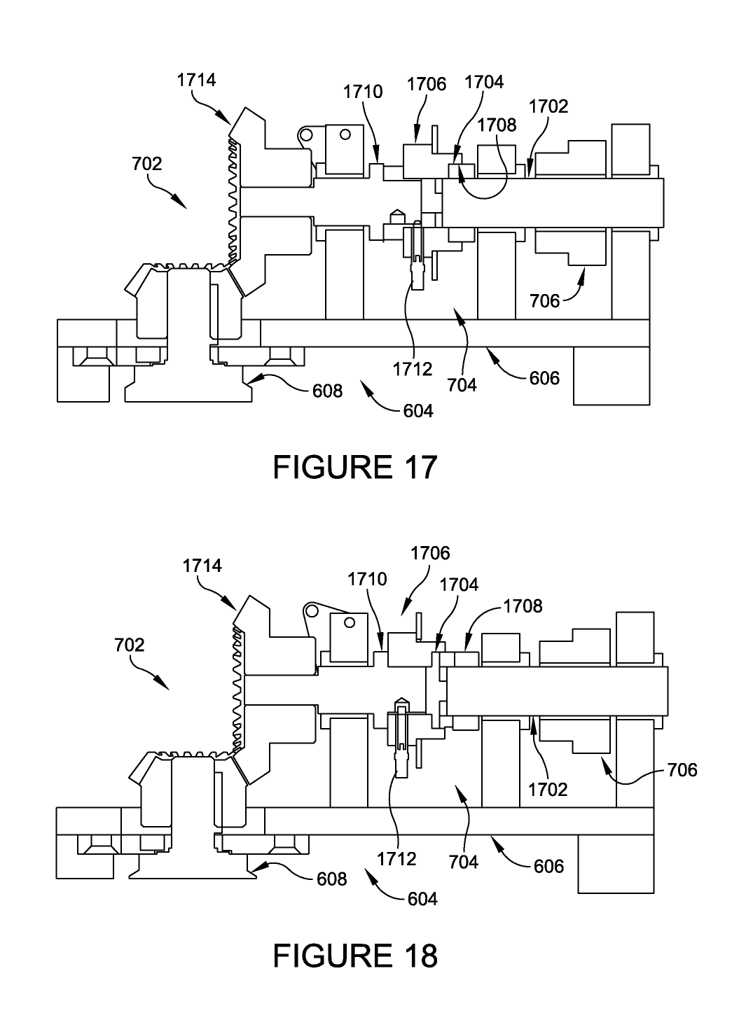

Should the drive system of CIA 100 fail to operate, for whatever reason, the drive system can be disengaged, CIA 100 will generally collapse, and CIA 100 can be removed from reactor. FIGS. 17 and 18 show how the drive disengagement mechanisms 504 and 704 generally operate. In particular, FIG. 17 illustrates an embodiment of drive disengagement mechanism 704 with collar 1702 engaged with spline 1704, while FIG. 18 illustrates the embodiment of FIG. 17 of drive disengagement mechanism 704, with collar 1702 disengaged with spline 1704.

Drive disengagement mechanisms 504 and 704 are featured on the slew drive 402 and articulation drive 604, respectively, but not on camera vertical actuation drive 810, as cameras 108 will not prevent failure recovery, regardless of their positions. Example FIGS. 17 and 18 show articulation drive system 604 for articulation mechanism 602 of deployment actuator 104, discussed above with respect to FIGS. 6 and 7. As noted above, drive system 604 is mounted to top 606 of base frame 516. Drive system 604 is comprised of a pneumatic brake motor 608, bevel gear set 702, drive disengagement mechanism 704, and spur gear set 706. As also noted above, this configuration allows drive 604 to be released for a failure event. Driveshaft 1702 of drive 604 that, by way of example, extends from drive gear 706 has spline 1704 machined into its end. Collar 1706, with corresponding spline 1708 is disposed between shaft 1702 and driveshaft 1710, extending from bevel gear set 702. Collar 1706 is able to slide on splines 1704 and 1708. In one position, the collar engages both splines, and in the other, it only engages one. In accordance with certain embodiments, indexing pin 1712, or the like, for locking or releasing movement of collar 1706, may be connected to a high-visibility bail, allowing operators to lower a hook into the reactor, pull the bail, and disengage the failed drive. In accordance with such embodiments, indexing pin may lock collar 1706 in the released position as shown in FIG. 18 to assist in such recovery. Slew drive disengagement mechanism 504, illustrated in FIG. 5 operates in a similar fashion. Once the problematic drive is disengaged, operators can manually manipulate CIA 100, if necessary, to remove CIA 100 from the reactor, such as with a long-handled tool to position CIA 100 in such a way that it can be removed from the reactor.

In accordance with an alternative embodiment a drive gear, such as drive gear 1714 or 510, may be disconnected from its driveshaft, such as shaft 1710, through the use of a shear pin connecting the gear to the shaft. Once the pin is forcibly sheared, the actuation or articulation mechanism would be free to collapse.

Thus, in accordance with the above-described embodiments, the number of individual components of CIA 100 may be minimized, in order to reduce the overall complexity, weight, and number of fasteners. This minimization may require more machined parts. For example, solid bushings may be used instead of ball bearings. Fasteners used in CIA 100 may be captured through the use of thread-locking compounds, spot welding, nylon locking elements, or deformed thread nuts. In certain embodiments, lock wire may not be used. All potential pockets where water can pool may have drain holes or other features to allow water to drain from CIA 100, such as upon raising CIA out of a reactor vessel. “Off-the-shelf” components may be used wherever possible to allow replacement parts to be easily procured, reducing manufacturing costs, maintenance costs and lead times. Lightweight materials such as aluminum may be used wherever practical.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A remotely deployed and operated camera inspection arm comprising:
a vertical actuator, comprising a bi-stable lightweight reelable tube configurable from a rolled retracted state to an extended tubular state by unrolling downwardly, and back to a rolled retracted state by rolling upwardly; and
an inspection camera attached to an end of the reelable tube.

2. The camera inspection arm of claim 1, wherein the reelable tube is a rolatube.

3. The camera inspection arm of claim 1, wherein the reelable tube comprises a material in which fibers are arranged such that the material is bi-stable and passively maintains its shape retracted as a coil or extended as a tube.

4. The camera inspection arm of claim 1, wherein the reelable tube comprises a material in which geometry of the material allows the material to become bi-stable and passively maintain its shape retracted as a coil or extended as a tube.

5. The camera inspection arm of claim 1, wherein the reelable tube comprises a material that creates a stiff structure that dampens unwanted motions at the camera when extended within the reactor.

6. The camera inspection arm of claim 1, wherein the inspection camera is submersible.

7. The camera inspection arm of claim 1, wherein the inspection camera is radiation tolerant.

8. The camera inspection arm of claim 1, wherein the inspection camera is radiation tolerant and submersible.

9. The camera inspection arm of claim 1, wherein the inspection camera is mounted inside a submersible package.

10. The camera inspection arm of claim 1, wherein the camera is mounted inside a radiation tolerant package.

11. The camera inspection arm of claim 1, wherein the camera is mounted inside a submersible and radiation tolerant package.

12. The camera inspection arm of claim 1, wherein the camera has a zoom function.

13. The camera inspection arm of claim 1, wherein the camera has at least one of a pan function and a tilt function.

14. The camera inspection arm of claim 1, wherein the camera has a pan-tilt-zoom function.

15. The camera inspection arm of claim 1, wherein tubular structure defined by the reelable tube accepts a camera control cable, guided into the tubular structure as the reelable tube is extended.

16. The camera inspection arm of claim 1, wherein the reelable tube is a rolatube and a control cable of the camera is guided into a an open tubular structure of the rolatube as the rolatube is extended.

17. The camera inspection arm of claim 1, wherein the camera moves vertically downward by extending the reelable tube and the camera moves vertically upward by retracting the reelable tube.

18. The camera inspection arm of claim 1, wherein, the vertical actuator comprises a rotated hub to extend and retract the reelable tube vertically.

19. The camera inspection arm of claim 1, wherein the vertical actuator comprises a guide for the reelable tube, forming the reelable tube into a tube upon extension and flattening the reelable tube upon retraction.

20. The camera inspection arm of claim 1, wherein attachment of the reelable tube to the camera maintains a working end of the reelable tube rolled in a cylindrical shape.

21. The camera inspection arm of claim 1, further comprising a central mast comprising a central vertical stanchion and a deployment actuator plate extending generally horizontal, perpendicular to the stanchion, at the bottom of the stanchion.

22. The camera inspection arm of claim 21, further comprising a deployment actuator mounted on the deployment actuator plate with the vertical actuator deployed on the deployment actuator.

23. The camera inspection arm of claim 22, further comprising a slew mechanism mounted on a bottom of the mast, operatively engaging and rotating the deployment actuator to deploy the camera horizontally, side-to side.

24. The camera inspection arm of claim 23, wherein the slew mechanism further comprises a disengagement mechanism.

25. The camera inspection arm of claim 22, wherein of the deployment actuators comprise a base frame and an articulation mechanism operatively mounted to a top of the base frame, the vertical actuator operatively coupled to the articulation mechanism, to deploy the camera horizontally, in and out.

26. The camera inspection arm of claim 25, wherein the articulation mechanism comprises a disengagement mechanism.

27. The camera inspection arm of claim 21, wherein the mast further comprises:
a hoist ring disposed at a top of the stanchion;
a wedge bumper extending from a side of the stanchion;
an extensible wedge cylinder extending in horizontally opposition relative to the wedge bumper another side of the mast; and
a locating plate disposed at a bottom of the mast extending generally horizontal, perpendicular to the mast.

28. The camera inspection arm of claim 1, wherein the mast further comprises a mount plate disposed at the top of the stanchion.

29. The camera inspection arm of claim 1, wherein the vertical actuator is configured for a boiling water reactor.

30. The camera inspection arm of claim 1, wherein the vertical actuator is configured for a hazardous environment.

31. A remotely deployed and operated boiling water reactor camera inspection arm comprising:
a central mast;
at least one deployment actuator mounted on the mast;
at least one vertical actuator deployed on the at least one deployment actuator; and
at least one inspection camera deployed on the one vertical actuator.

32. The boiling water reactor camera inspection arm of claim 31, wherein the at least one vertical actuators each comprise a reelable tube having a rotated hub to extend and retract the reelable tube, moving the at least one camera vertically.

33. The boiling water reactor camera inspection arm of claim 32, wherein the reelable tube is a bi-stable and lightweight, reconfigurable from a rolled retracted state to an extended tubular state by unrolling, and back to a rolled retracted state by rolling.

34. The boiling water reactor camera inspection arm of claim 32, wherein the reelable tube is a rolatube.

35. The boiling water reactor camera inspection arm of claim 32, wherein the at least one vertical actuators each comprise a guide for the reelable tube forming the reelable tube into a tube upon extension and flattening the reelable tube upon retraction.

36. The boiling water reactor camera inspection arm of claim 32, wherein one of the at least one cameras is attached to an end of the reelable tube and the camera maintains a working end of the reelable tube rolled in a cylindrical shape.

37. The boiling water reactor camera inspection arm of claim 31, further comprising a slew mechanism mounted on a bottom of the mast, operatively engaging and rotating the at least one deployment actuator to deploy the at least one camera horizontally, side-to side.

38. The boiling water reactor camera inspection arm of claim 37, wherein the slew mechanism further comprises a disengagement mechanism.

39. The boiling water reactor camera inspection arm of claim 31, wherein each of the at least one deployment actuators comprise a base frame and an articulation mechanism operatively mounted to a top of the base frame, the at least one vertical actuator operatively coupled to the articulation mechanism, to deploy the at least one camera horizontally, in and out.

40. The boiling water reactor camera inspection arm of claim 39, wherein the articulation mechanism comprises a disengagement mechanism.

41. The boiling water reactor camera inspection arm of claim 39, wherein the articulation mechanism comprises a four-bar mechanism mounted to the top of the base frame.

42. The boiling water reactor camera inspection arm of claim 31, wherein the mast further comprises:
a central vertical stanchion;
a hoist ring disposed at a top of the stanchion;
a wedge bumper extending from a side of the stanchion;
an extensible wedge cylinder extending in horizontally opposition relative to the wedge bumper another side of the mast;
a locating plate disposed at a bottom of the mast extending generally horizontal, perpendicular to the mast, the locating plate defining a beam bolt interface; and
a deployment actuator plate extending generally horizontal, perpendicular to the mast, at the bottom of the mast.

43. The boiling water reactor camera inspection arm of claim 42, wherein the mast further comprises a mount plate disposed at the top of the stanchion.

44. The boiling water reactor camera inspection arm of claim 31, wherein the inspection camera is radiation tolerant.

45. The boiling water reactor camera inspection arm of claim 31, wherein the inspection camera is submersible.

46. The boiling water reactor camera inspection arm of claim 31, wherein the inspection camera has one or more of a pan function, a tilt function, or a zoom function.

47. A method comprising:
positioning one or more cameras of a boiling water reactor camera inspection arm around reactor pipework, horizontally, by at least one of rotating, extending and retracting a deployment actuator of the boiling water reactor camera inspection arm; and
moving the one or more cameras vertically on an end of a reelable tube deployed from a vertical actuator deployed from the deployment actuator to inspect the reactor.

48. The method of claim 47, further comprising:
lowering the boiling water reactor camera inspection arm into a reactor vessel, between the reactor vessel and a reactor shroud; and
aligning a locating plate of the boiling water reactor camera inspection arm on reactor structure to install the boiling water reactor camera inspection arm for inspection of at least a portion of the reactor;

49. The method of claim 48, further comprising extending a wedge cylinder from a mast of the boiling water reactor camera inspection arm to engage the shroud and the vessel with the wedge cylinder and an opposing wedge bumper, stabilizing the boiling water reactor camera inspection arm against the shroud and the vessel.

50. The method of claim 48, wherein the boiling water reactor camera inspection arm is lowered using a hoist ring disposed in a top of a mast of the a boiling water reactor camera inspection arm.

51. The method of claim 48, further comprising retracting articulation mechanisms of deployment actuators of the boiling water reactor camera inspection arm before lowering the boiling water reactor camera inspection arm, or raising the boiling water reactor camera inspection arm.

52. The method of claim 48, wherein aligning comprises positioning the locating plate of the boiling water reactor camera inspection arm over bolts on a top of a ram's head of a reactor jet pump, the bolts acting as horizontal capture pins, indexing with the locating plate.

53. The method of claim 52, wherein the bolts are beam bolts.

54. The method of claim 47, further comprising inspecting a top of a reactor structure using the one or more cameras while lowering the boiling water reactor camera inspection arm into a reactor vessel, between the reactor vessel and a reactor shroud or while raising the boiling water reactor camera inspection arm out of the reactor vessel.

55. The method of claim 47, further comprising recovering the boiling water reactor camera inspection arm from failure by disengaging a slew drive and articulation drive of the deployment actuator and removing the boiling water reactor camera inspection arm from a reactor vessel into which it is deployed.

56. The method of claim 47, further comprising compensating for back pressure in a reactor vessel in which the boiling water reactor camera inspection arm is deployed by pressurizing pneumatic motors and pneumatic lines of the boiling water reactor camera inspection arm.

57. A remotely deployed and operated boiling water reactor camera inspection arm comprising:
a mast having a central vertical stanchion and a plate extending generally horizontal, perpendicular to the stanchion, at the bottom of the mast;
a pair of pneumatically actuated deployment actuators, one mounted each side of the mast stanchion, on the plate, each deployment actuator comprising a pneumatically actuated articulation mechanism operatively mounted to a top of a base frame of each of the deployment actuators;
a vertical actuator deployed on an end of each of the articulation mechanisms, each vertical actuator comprising a rolatube, the rolatube having a pneumatically rotated hub extending and retracting the rolatube;
a radiation tolerant, submersible inspection camera deployed on an end of the rolatube of each vertical actuator, the rolatube extending and retracting to deploy the camera vertically;
a pair of pneumatically actuated slew mechanisms mounted on a bottom of the mast, each operatively engaging and rotating a deployment actuator to deploy the camera horizontally, side-to side, the slew mechanism also comprising a disengagement mechanism; and
a pneumatically actuated articulation drive of each articulation mechanism operative to extend and retract the articulation mechanism, deploying the cameras horizontally, in and out, the articulation drive also comprising a disengagement mechanism.

58. The boiling water reactor camera inspection arm of claim 57, wherein the camera has a pan-tilt-zoom function.

59. The boiling water reactor camera inspection arm of claim 57, further comprising a back pressure compensation bubble tube deployed from the boiling water reactor camera inspection arm such that pressure in the bubble tube is used as a reference to set the back pressure of a pneumatic system of the boiling water reactor camera inspection arm using a differential pressure regulator.
